(19) United States
(12) Patent Application Publication
(10) Pub. No.: US 2018/0283057 A1
(43) Pub. Date: Oct. 4, 2018

(54) Delayed Emergency Release Unit

(71) Applicant: Westinghouse Air Brake Technologies Corporation, Wilmerding, PA (US)

(72) Inventors: Andre Stojc, Ile Bizard (CA); Daniel Filion, Prevost (CA)

(21) Appl. No.: 15/765,791

(22) PCT Filed: Oct. 31, 2016
(86) PCT No.: PCT/US16/59674

§ 371 Date: Apr. 4, 2018

Related U.S. Application Data
(60) Provisional application No. 62/250,550, filed on Nov. 4, 2015.

(51) Int. Cl. E05B 81/08; E05B 79/20; E05B 47/06; E05B 83/36; B61D 19/00; B61D 19/02

(52) U.S. Cl. CPC E05B 81/08; E05B 79/20; B61D 19/023; E05B 83/363; B61D 19/007; E05B 47/06

(57) ABSTRACT

The manual release mechanism described herein enables a passenger to attempt to manually open the transit door, but delays opening until the vehicle is no longer moving. A motion transfer device (14) moves to an unlocking position of the door lock (10) only when the manual release mechanism is activated to store energy in a mechanical energy storage device (40), and an electromechanical device (26) is de-energized to release the motion transfer device (14).

### CROSS REFERENCE TO RELATED APPLICATIONS

This application claims the benefit to U.S. Provisional Application. No. 62/250,550 filed Nov. 4, 2015, the disclosure of which is hereby incorporated in its entirety by reference.

### BACKGROUND OF THE INVENTION

### Field of the Invention

This invention relates to a manual emergency release mechanism for transit vehicle doors. It is essential that transit vehicle doors be locked during normal operation while the vehicle is moving so that a passenger leaning against or falling against a door does not push open the door and fall out of the vehicle. However, in an emergency, there must be a provision for unlocking the door. Certain Transit Authority operational procedures require the train to have reached full stop prior to allowing the doors to be unlocked, even in an emergency situation.

In the case of an emergency, a passenger actuates a release handle from inside the transit vehicle. The handle (rotating or linear motion) pulls on a release cable. The release cable is connected to the door actuator/lock mechanism to unlock the doors.

The manual release mechanism described herein enables a passenger to attempt to manually open the transit door, but delays opening until the vehicle is no longer moving.

FIG. 4 illustrates one of many types of transit vehicle doors. Specifically, FIG. 4 is a plan view of a typical slide-glide door. The door panels 50 move from the closed position to an open position generally perpendicular to the closed position. The door panels 50 are hung from a track 51 that is parallel to the closed door by a follower 52. The door is caused to open by rotation of a door post 56 connected to the leading edge (when opening] by a lever 57 extending from the door post 56. The door post 56 is caused to rotate by a door operator 53 via a connecting rod 54 and a bell crank 55.

A door lock may be associated with any number of the elements from the door operator to the door post and door panel.

### DESCRIPTION OF RELATED ART

Usually, a manual release cable is coupled directly to a door locking mechanism and the door panels become unlocked when the cable is pulled. Unfortunately, if the train is still moving, stopped between stations, or the door is on the wrong side of the vehicle while adjacent a station platform, and if the door is manually unlocked, the passenger could get injured.

In the past, to prevent a passenger from leaving the car when unsafe to do so after the release handle has been actuated, the motor driving the doors was energized to attempt to keep the doors closed. However, the passenger with extra force can still force the doors open as the motors can only apply a limit amount of resistance force. Driving the doors in the closed position can cause the motors to overheat to their detriment. Also, the passenger can damage the door control mechanism when forcing the doors.

Also, in the past, a mechanism was provided to prevent the release handle from being moved so long as it is unsafe and, thus, the release cable from being pulled. However, this can frustrate the passenger and result in the handle being broken by the application of too much force. Also, when safe to do so, the passenger must again actuate the release handle. The passenger must know when it is safe to do so.

### SUMMARY OF THE INVENTION

Briefly, according to this invention, there is provided an emergency manual door lock release mechanism for releasing a door lock actuator mechanism on a transit vehicle door comprising: a motion transfer device for releasing the door lock, an electromechanical device for fixing the position of the transfer device when energized and releasing the motion transfer device when de-energized, a mechanical energy storage device, a manual release device for energizing the mechanical energy storage device to bias the motion transfer device to move to an unlocking position, such that the door lock will only be manually released when the manual release device is activated to store energy in the mechanical energy storage device and the electromechanical device is de-energized to release the motion transfer device.

The motion transfer device may, for example, be a slide connected to a cable or lever connected to the door lock. The mechanical energy storage device may, for example, be a coil spring. The electromechanical device may, for example, be an electromagnet or solenoid. The manual release device may, for example, be a handle, cable, lever, or combination thereof.

Briefly, according to a specific embodiment of this invention, there is provided an emergency manual door lock release mechanism for releasing a door lock on a transit vehicle door comprising: a base plate for being secured to the transit vehicle, a sliding plate abutting and movable relative to the base plate, said sliding plate having at least one elongate slot, at least one pin fixed to the base plate extending into the at least one elongate slot constraining the relative movement between the base plate and sliding plate in a lateral direction, an electromagnet support bracket for being secured to the transit vehicle, an electromagnet supported by the electromagnet support bracket, a manual release cable, a first end bracket fixed at or near one lateral end of the base plate and having an aperture therein for receiving the sleeve of a manual release Bowden cable, a magnetizable steel plate, a second end bracket fixed at or near the opposite lateral end of the sliding plate from the first end bracket and supporting the magnetizable steel plate to be captured by the electromagnet, a coil spring that stores energy when stretched and which is anchored directly or indirectly at one end to the second end bracket and connected at the other end directly or indirectly to the manual release cable, the motion transfer means connected to the second end bracket, such that when the sliding plate moves away from the electromagnet, a door lock actuator mechanism will be manually released and the door unlocked only when the manual release cable is pulled to store energy in the coil spring, and the electromagnet is de-energized to release the magnetizable steel plate. The electromagnet electrical power is typically under the control of an ON/OFF signal issued by a combination of the train berthing system and the zero-speed system. When the train is properly berthed and at zero speed, the electromagnet is de-energized. It is energized whenever these conditions are not met.

Also, typically, there is a separate pull cable on the door lock actuating mechanism (not shown) allowing the door to be unlocked in normal service independently of the emergency release.

### BRIEF DESCRIPTION OF THE DRAWINGS

Further features and other objects and advantages of the invention will become apparent from the following detailed description made with reference to the drawings.

FIG. 1 is a schematic and prospective view of an emergency manual door lock release mechanism for releasing a door lock on a transit vehicle according to this invention when energy is not stored in the spring and release is not actuated.

FIG. 2 is a schematic and prospective view of an emergency manual door lock release mechanism for releasing a door lock on a transit vehicle according to this invention with energy stored in the spring but the door lock is not released.

FIG. 3 is a schematic and prospective view of an emergency manual door lock release mechanism for releasing a door lock on a transit vehicle according to this invention when manual release has been attempted and the door lock has been released.

FIG. 4 illustrates a transit vehicle with one of the many types of transit vehicle doors to which this invention has application.

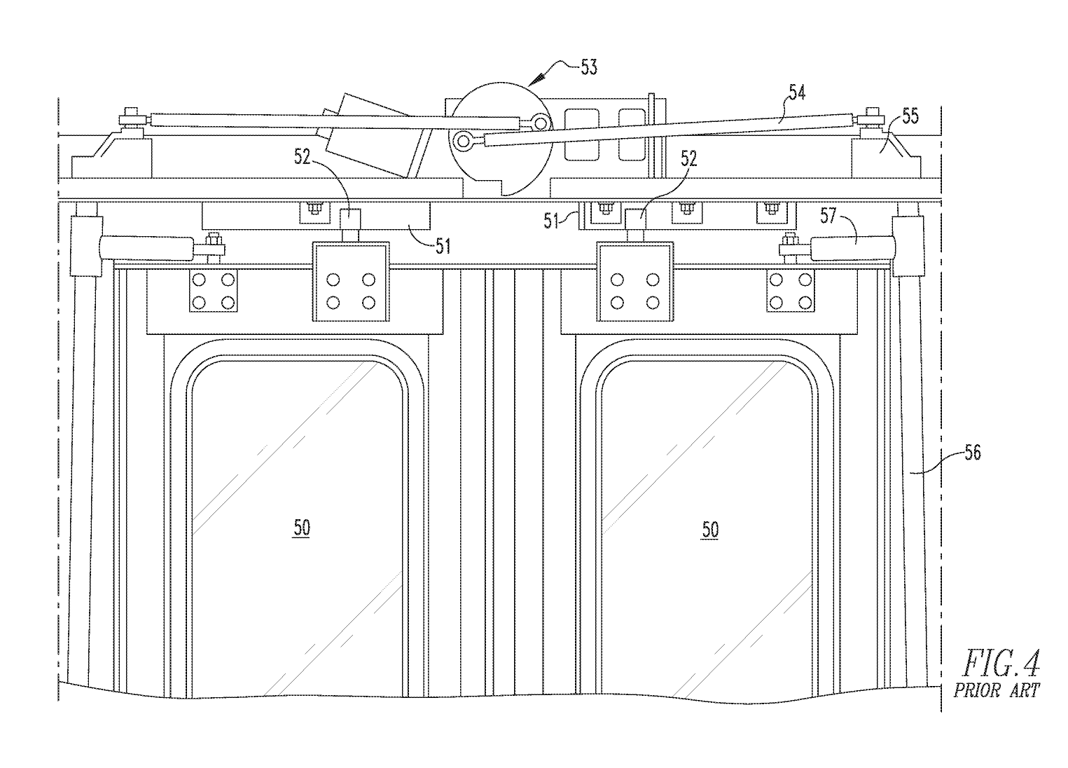

### DESCRIPTION OF THE INVENTION

Referring now to the drawings, an emergency manual door lock release mechanism for releasing a door lock 10 on a transit vehicle door comprises a base plate 12 for being secured to a transit vehicle wall or frame. A sliding plate 14 abuts and is movable relative to the base plate 12. The sliding plate has at least one elongate slot 16, 18. At least one pin 20, 22 is fixed to the base plate 12 extending into the at least one elongate slot constraining the relative movement between the base plate and sliding plate in a lateral direction indicated by the double head arrow.

An electromagnet support bracket 24 is secured to the transit vehicle adjacent the base plate 12 near one lateral end. An electromagnet 26 is supported by the electromagnet support bracket 24.

A first end bracket 30 is fixed at or near one lateral end of the base plate 12 and has an aperture 32 therein for receiving the sleeve of a manual release Bowden cable 34. A second end bracket 38 is fixed at or near the opposite lateral end of the sliding plate 14 from the first bracket. The second end bracket positions a magnetizable steel plate 36 to be captured by the electromagnet 26.

A coil spring 40, which extends in the lateral direction, stores energy when stretched. The coil spring 40 is anchored directly or indirectly at one end to the second end bracket 38 and is connected at the other end directly or indirectly to the manual release cable 34. A motion transfer cable, lever or bar 42 is connected to the second end bracket 38, such that when the sliding plate 14 moves away from the electromagnet 26, the door lock 10 will be released only when the manual release cable 34 is pulled to store energy in the coil spring 40, and the electromagnet 26 is de-energized to release the magnetic plate 36.

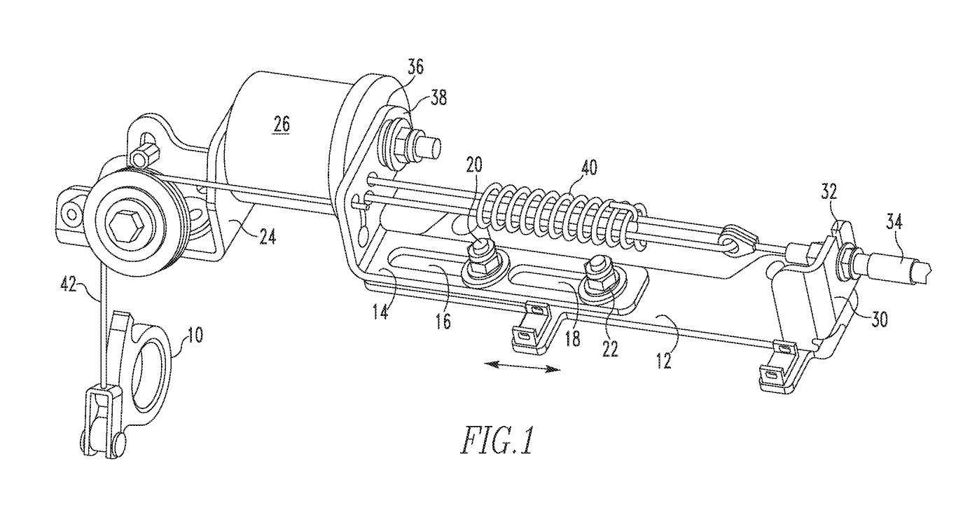

As shown in FIG. 1, the coil spring 40 is relaxed and the electromagnet 26 is energized and the door is locked. This is the normal position when the transit vehicle is moving between stations.

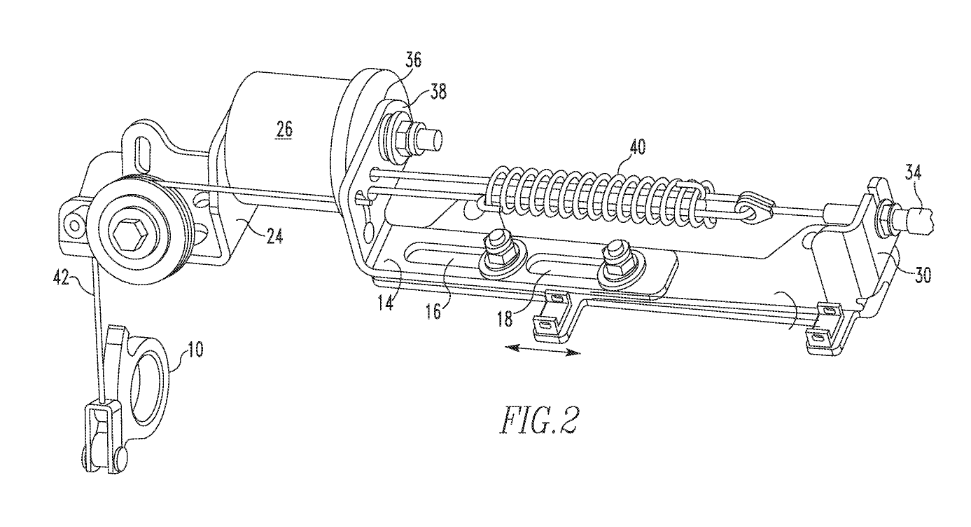

As shown in FIG. 2, the coil spring 40 is energized as a passenger, for example, has pulled the manual release cable 34, but the transit vehicle doors are not unlocked as the electromagnet is still energized. The manual release cable may be maintained pulled by a latch associated with the cable and first end plate.

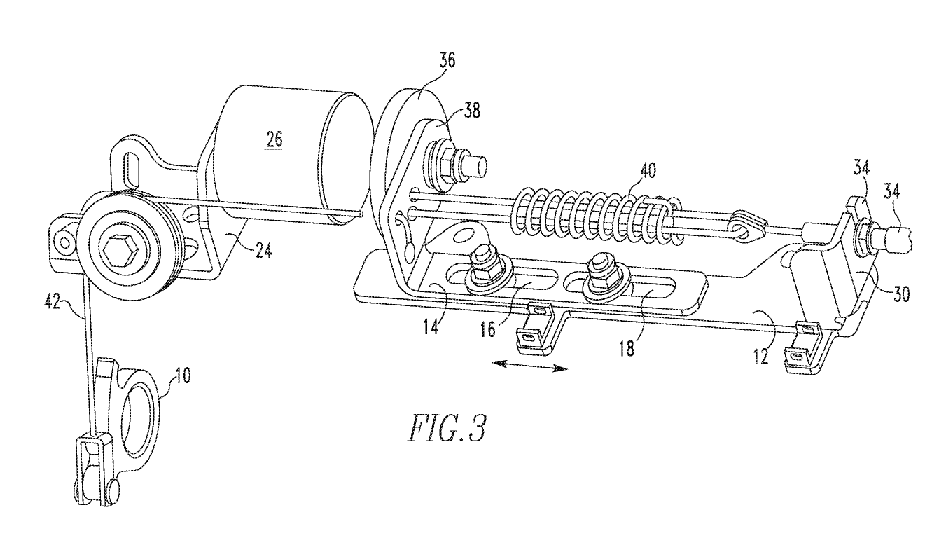

As shown in FIG. 3, the electromagnet 26 is de-energized and the sliding plate 14, under the bias of the coil spring 40, has moved the sliding plate 14 away from the electromagnet 26 pulling the motion transfer cable 42 to unlock the door lock 10. Unlocking is delayed until the electromagnet 26 is de-energized when the transit vehicle comes to a stop.

Having thus defined our invention with the detail and particularity required by the Patent Laws, what is desired protected by Letters Patent is set forth in the following claims.

The invention claimed is

1. An emergency manual door lock release mechanism for releasing a door lock on a transit vehicle door comprising: motion transfer means, an electromechanical device for fixing the position of the transfer means when energized and releasing the motion transfer means when de-energized, a mechanical energy storage means, a manual release means for energizing the mechanical energy storage means to bias the motion transfer means to move to a unlocking position, such that the door lock will only be manually released when the manual release means is activated to store energy storage in the mechanical energy storage means and the electromechanical device is de-energized to release the motion transfer means.

2. An emergency manual door lock release mechanism for releasing a door lock on a transit vehicle door comprising: a base plate for being secured to the transit vehicle, a sliding plate abutting and slidable relative to the base plate, said sliding plate having at least one elongate slot, at least one pin fixed to the base plate extending into the at least one elongate slot constraining the relative movement between the base plate and sliding plate in a lateral direction, an electromagnet support bracket for being secured to the transit vehicle, an electromagnet supported by the electromagnet support bracket, a manual release cable, a first end bracket fixed at or near one lateral end of the base plate having an aperture therein for receiving the manual release cable, a magnetizable steel plate, a second end bracket fixed at or near the opposite lateral end of the sliding plate from the first end bracket and supporting the magnetizable steel plate to be captured by the electromagnet, a coil spring that stores energy when stretched and which is anchored directly or indirectly at one end to the second end bracket and connected at the other end directly or indirectly to the manual release cable, the motion transfer means connected to the second end bracket such that when the sliding plate moves away from the electromagnet the door lock will be manually released only when the manual release cable is pulled to store energy in the coil spring and the electromagnet is de-energized to release the magnetizable steel plate.
